(19) United States
(12) Patent Application Publication
(10) Pub. No.: US 2004/0058103 A1
(43) Pub. Date: Mar. 25, 2004

(54) Flat-bottomed reclosable package with gussets

(76) Inventors: Terrance C. Anderson, New Richmond, WI (US); Eric J. Aasen, Glenwood City, WI (US)

Correspondence Address: OPPENHEIMER WOLFF & DONNELLY LLP, 45 SOUTH SEVENTH STREET, SUITE 3300, MINNEAPOLIS, MN, 55402, US

(21) Appl. No.: 10/657,784

(22) Filed: Sep. 8, 2003

Related U.S. Application Data
(60) Provisional application No. 60/410,149, filed on Sep. 12, 2002.

(51) Int. Cl. F16L 1/00

(52) U.S. Cl. 428/34.1

(57) ABSTRACT

A stand-up reclosable package is formed with a top and bottom seal, and a length-wise seal. The end of the bag is gusseted to form a flat, square shaped surface for the package to stand up. Another seal is formed length-wise along one side of the package to form the sides of the pack, defining the interior volume of the package. The top of the bag may be sealed in a manner consistent with existing vertical form fill and seal technology. The top of the package may have a reclosable feature. Additionally, the present invention provides a method of forming said reclosable stand-up package, including filling the package with desired contents as the package is formed and sealed.

### CROSS REFERENCE TO RELATED APPLICATIONS

This application claims the benefit of U.S. Provisional Patent Application Serial No. 60/410,149, filed Sep. 12, 2002.

### FIELD OF THE INVENTION

The present invention relates to manufacturing plastic containers. More particularly, the present invention relates to a reclosable bag or pouch capable of standing in an upright position on its own when filled with items, and to a method of making the bag.

### BACKGROUND OF THE INVENTION

Consumers desire stand-up, reclosable plastic bags and containers for their convenience for filling and storing dried foods, as well as liquid foods. There currently exist many so-called stand-up, freestanding or self-standing plastic bags. Known in the art are plastic bags incorporating a zipper-type closure device along the top opening or mouth of the bags. Further, there are self-standing plastic bags that incorporate a zipper-type closure device along its mouth.

Some existing stand-up bags attempt to provide the stand-up capability merely by use of a simple bottom gusset alone, or, supplemented with seals added in the gusset structure. However, a simple bottom gusset sealed at its sides does not provide a normal consumer plastic bag with a stand-up feature with an adequate reclose feature. Such plastic bags are typically made from polyethylene film, which often is too limp to stand up from the gusseted bottom to permit easy reclosing of the bag. Consequently, it is difficult for the customer to get the bag to rest on a surface without toppling over or easily open and reclose, in both cases typically spilling the contents of the bag.

Other consumer plastic bags have films of greater thickness, thus allowing them to stand up from a simple bottom gusset. Still other stand-up bags seal the bottom gusset into a base that is much more stable than the simple bottom gusset. Typically, these bottom gusset bags require gussets to be located on the top and bottom seals of the bag. Having a gusset on the top seal adds a great deal of complexity to the bag, especially when a reclosable feature is also incorporated into the bag. Specifically, multiple layers of film are folded within the seal, not permitting normal reclosable features to be used (e.g., zipper-type). Accordingly, the bag assembly and manufacturing process is more complex. Consequently, more time is needed to assemble the bags, leading to higher manufacturing costs.

Furthermore, quite a bit of difficulty has been experienced in filling and emptying all of the above-disclosed bags. The bags do not stand up easily when empty, and a zipper-type closure is difficult to maintain in an open position when filling and emptying the bag.

In order to provide a cost effective gusseted stand-up reclosable bag, it is contemplated that further improvements are needed before consumers will be provided with a plastic bag that completely meets their needs. These improvements must relate to a more stable stand-up base, one that will faithfully support the bag when empty as well as during and after filling, and a bag that allows for only the bottom of the package to be gusseted. Also, there is a desire for a simpler and less costly method of assembling a gusseted stand-up reclosable bag.

### BRIEF SUMMARY OF THE INVENTION

The present invention provides a stand-up gusseted bag with a reclosable feature and method of making same designed to satisfy the aforementioned needs. The purpose of the present invention is to provide simple inexpensive bags or stand-up pouches that are able to contain products such as snacks, confections, pet foods, liquids and the like.

In one embodiment of the present invention, a package is formed with a top and bottom seal, and a length-wise seal. The bottom seal of the package is made by first folding the sides of the bag towards the center. While the sides are being held in place, the end of the bag is sealed (e.g., gusseted) to form a flat, square shaped surface for the package to stand up. Another seal is formed length-wise along one side of the package to form the sides of the pack, defining the interior volume of the package. The top of the bag is sealed in a manner consistent with existing vertical form fill and seal technology. Specifically, a flat, full-length seal across the width of the bag is made. Since there are no gussets in the top seal, the addition of a reclosable feature is possible.

The reclosable feature of the present invention may be any conventional reclosing mechanism, such as a zipper, zipper-slider seal, easy-snap technology, or the like.

Additionally, the present invention provides the method of forming said reclosable stand-up package, including filling the package with desired contents as the package is formed and sealed.

Alternatively, a gusset may be formed on the top of the package.

The package may be created in many styles. For example, one style involves placing an opening at the top of the package and then covering it with an additional piece of packaging film attached to the inside of the bag to maintain the package's integrity prior to initial opening. This opening may be a slit, a perforation, a punched opening, or the like. This opening may also be reinforced to eliminate the tendency of some packaging films to tear down the length of the bag.

It is an object of the present invention to provide an efficient and cost effective apparatus and method for reclosing gusseted stand-up packages and retaining the contents therein.

It is another object of the present invention to provide the package with the ability to maintain a stand-up capability as the contents of the package are consumed or removed.

These and further aspects, objects and advantages of the present invention will become clearer in light of the following detailed description of the illustrative embodiments of this invention described in connection with the drawings.

### BRIEF DESCRIPTION OF THE DRAWINGS

Further objects and advantages of the present invention can be seen by reading the following detailed description in conjunction with the drawings in which:

FIG. 1 is a perspective view of an embodiment of the present invention;

FIG. 2 is a side view of the embodiment of FIG. 1;

FIG. 3 is a rear view of the embodiment of FIG. 1.

FIG. 4A is a perspective view of the embodiment of FIG. 1 with the package in the process of being opened.

FIG. 4B is a perspective view of an alternative embodiment of the present invention with the package in the process of being opened.

FIG. 5 is a perspective view of the present invention with the package in an opened orientation.

FIG. 6 is a perspective view of the present invention with the package in a closed position.

FIG. 7 is cross-sectional view of the reclosable mechanism of FIG. 6 in the closed position.

FIG. 8 is a perspective view of the present invention with the package full of goods in a closed position.

FIG. 9 is a perspective view of the present invention with the package full of goods in an opened position.

FIG. 10 is a diagram of an embodiment of the formation of the present invention via vertical form fill and seal machinery.

FIG. 11 is a diagram of an alternative embodiment of vertical form fill and seal machinery to form the present invention.

FIG. 12 is a diagram of a further alternative embodiment of vertical form fill and seal machinery to form the present invention.

### DETAILED DESCRIPTION OF THE INVENTION

As mentioned above, the present invention relates to stand-up gusseted reclosable packages and the method of making the same. This invention may be applied to many different types of packaging machinery, and to other processing equipment and operations. For example, the present invention may be used to produce products or other containers for holding and containing materials. Additionally, the present invention may be used in self-standing items to display advertising, or formed using vertical form fill and seal (VFFS) machines as well as horizontal form fill and seal (HFFS) machines.

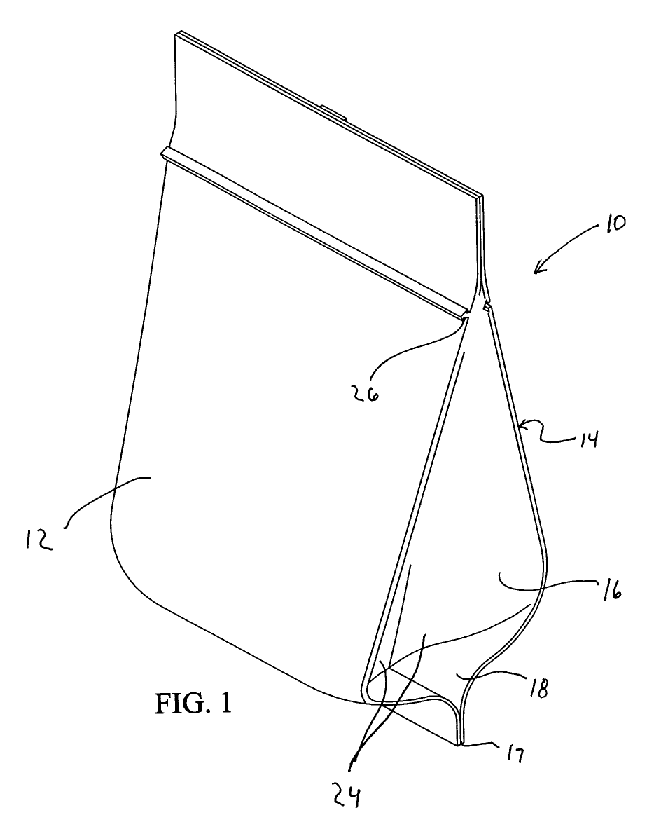

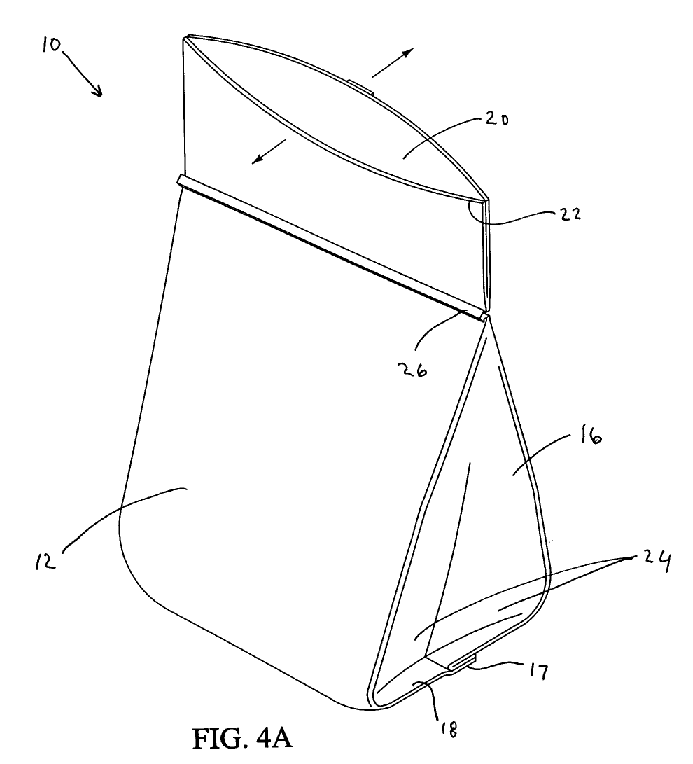

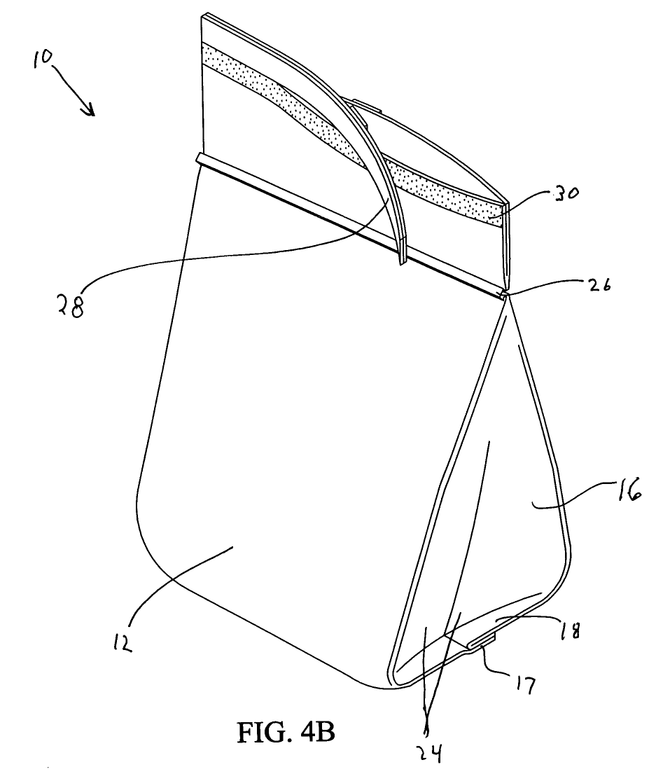

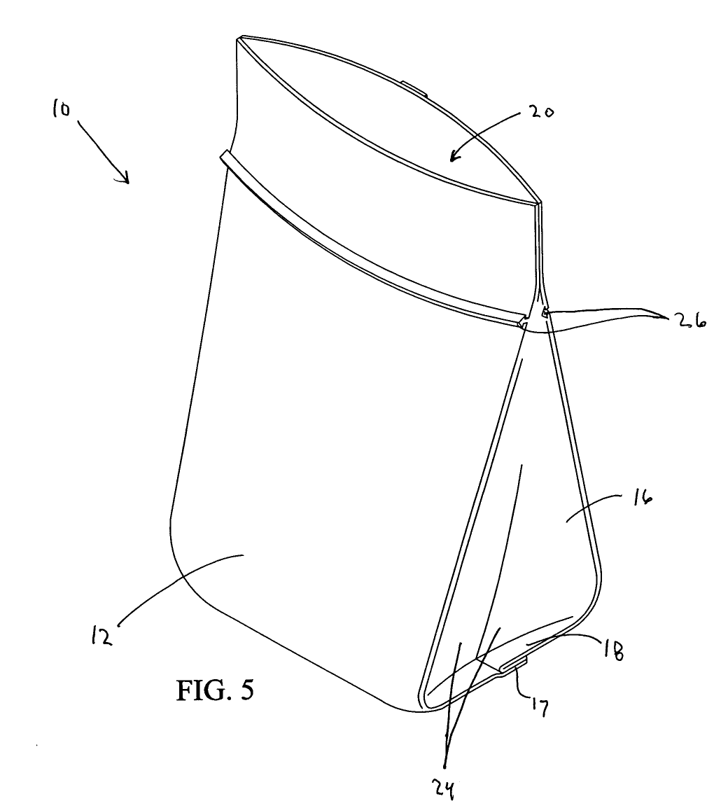

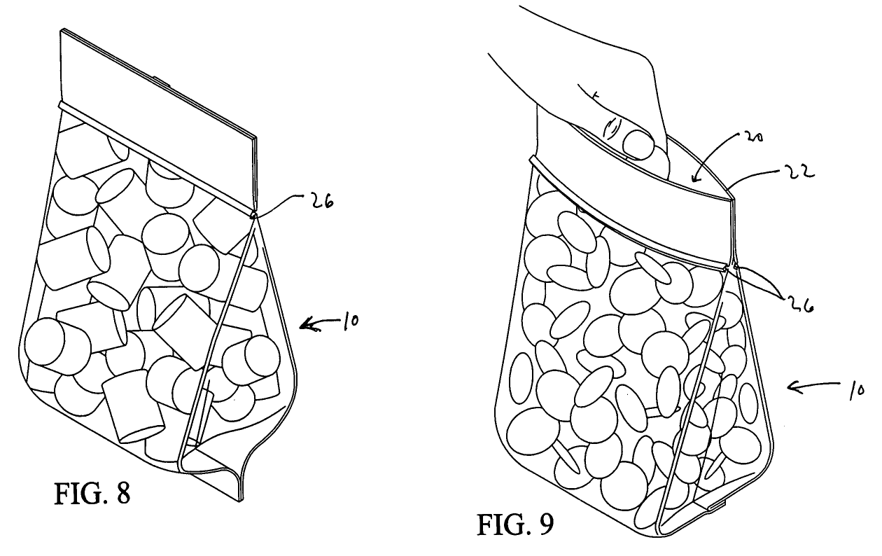

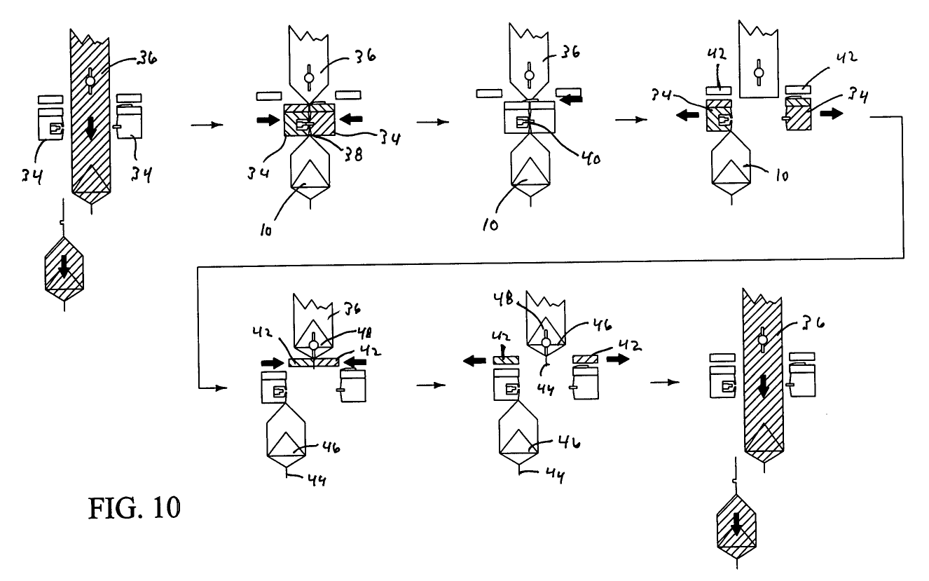

Shown in FIGS. 1-9, is a stand-up gusseted reclosable bag 10. The present invention may be formed using machinery such as VFFS machinery, as shown in FIGS. 10-12 and discussed below.

Referring to FIGS. 1-5, a stand-up plastic bag 10 has a front wall 12, a rear wall 14, a pair of gusseted sides 16 and a flat bottom wall or portion 18, defining an interior volume 20. An open bag mouth 22 is defined at the upper edges of the walls (12,14,16).

In one embodiment, the front wall 12 and rear wall 14 has opposite longitudinal edges joined together by a seal at contiguous portions of material on the exterior surface thereof, which complete formation of a seal as a continuous self-standing structure that defines, with bottom wall 18, a stand-up base of the bag.

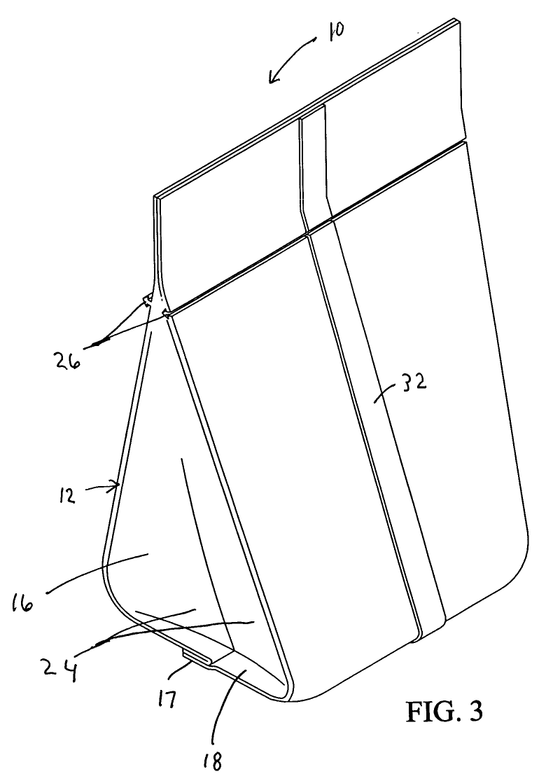

The gusseted sides 16 have portions 24 interconnected to form a substantially flat bottom wall extending between the front 12 and rear 14 walls, and sides 16. Sides 16 may also have lower portions joined by seals to lower portions of the front 12 and rear 14 walls at contiguous portions of material to form a support band 17 that connects to and extends below the bottom wall 18. For example, as shown in FIG. 3, the bag 10 may have a base seal that utilizes gussets 16 on the sides of bag 10 in forming the flat bottom portion or base 18.

The walls are composed of a multi-layered film. The film is preferably a plastic, for example, polyethylene, and may be heat-sealable and/or coextruded. However, it is contemplated that any paper, thermoplastic, or like material may be utilized. For example, materials may be used to permit use of the package in a microwave, freezer and refrigerator.

Referring to FIGS. 1-3, 4A and 4B, 5 and 9, the mouth opening 22 at the top of bag 10 may be of numerous styles such as a slit, a perforation or a punched opening. The reclosable feature of the present invention applied to close the mouth opening may be any conventional re-closing mechanism. For example, a zipper, slider, seal, Zip-Loc™, or the like, or easy-snap technology may be utilized.

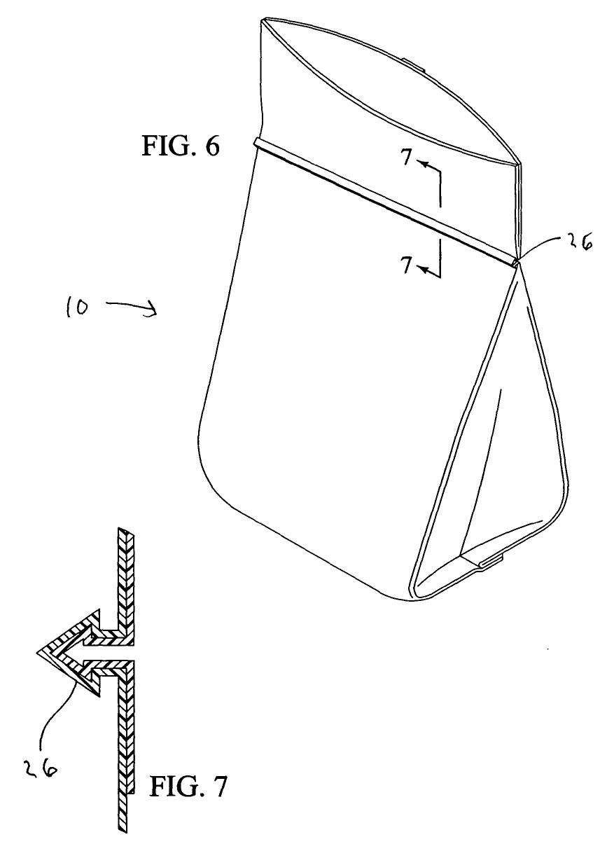

As shown in FIGS. 1-9, easy-snap technology 26 is a reclosable feature for packages. The Easy Snap device 26 utilizes a fold over snap feature as shown in FIGS. 6 and 7. The easy-snap technology is disclosed in U.S. Pat. Nos. 6,350,057, 5,983,594, 5,944,425, 5,937,615, 5,928,749 and 4,679,693, all to Forman, and is incorporated herein by reference.

As shown in FIGS. 1-4B, mouth opening 22 may also be reinforced to eliminate the tendency of some packaging films to tear down the length of the bag. Mouth opening 22 may also be covered on the exterior of the package to protect or close off the opening with various removable materials such as a strip of tape 28, a label or the like. An adhesive 30 may be utilized to supplement the resealable easy-snap device 26. Alternatively, a seal may be used at the top of the bag to completely cover the bag opening 22, as well as the resealable feature.

In its most common environment, the method of assembly of the present invention is a component of a larger manufacturing operation and results in a gusseted reclosable stand-up bag 10. For example, the self-standing flat-bottomed bag with a reclosable feature may be automatically formed on a VFFS machine, as shown in FIGS. 10-12.

One embodiment of formation of the present invention, a vertical form fill and seal machine is shown in FIG. 10. In this embodiment, a longitudinal seal is first formed through normal VFFS machine operation creating a tube of film that travels down a round forming collar. The VFFS machine advances bag film exactly one bag length and stops.

Referring to FIG. 10, in operation, a sealing bar and feature press 34 close simultaneously on a web of multi-layered film 36, and a top transverse seal 38 of the bag 10 is formed. The reclose feature (i.e., Easy Snap, Zipper, Slider) is may be applied at this time. While the top seal and reclose feature are being formed, a serrated cut-off knife 40 is actuated through the film 36 separating the newly formed bag 10 from the end of a tube of film 36. The cut-off knife is then retracted. Subsequently, the sealing bar and feature press 34 open simultaneously. The feature press 34 may continue to grasp film 36 to increase dwell time for proper reclose feature formation. The end of the film tube 36 relaxes to its natural round shape.

A secondary sealing bar and gusseting fingers 42 close on film 36 simultaneously creating a bottom transverse seal 44 and the flat stand-up geometry 46 of bag 10. Two separate gusseting fingers 48 are located on opposite sides of bag 10. A specially designed rectangular forming tube attachment on the inside of the film tube 36 aids in the formation of the flat bottom geometry 46. The width and depth of the gusseted portion of the bag are determined by the size of this attachment, which is determined by the machine user.

Product may begin to be dumped into bag 10 as soon as the secondary seal bar and gusseting fingers 42 close. The forming tube attachment, gusseting finger and secondary sealing bars 42 are preferably mechanically aligned to the bottom edge of film 36 to ensure that the bottom seal 44 is formed exactly along the edge of film 36. This ensures that no excess film has to be trimmed from the bag to provide a neat seal appearance. Additionally, no extra film must be discarded during the formation of the bottom seal.

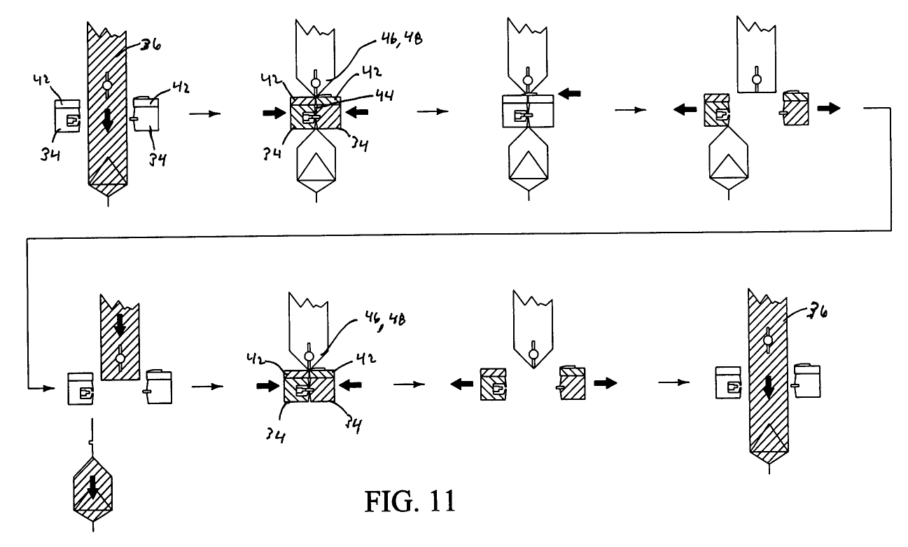

In FIG. 11, an alternative embodiment of VFFS machinery is shown. This embodiment is a variation of the embodiment of FIG. 10 in which the film tube 36 is advanced a second time during the formation of bag 10. This allows the bottom edge of film 36 to be realigned to the sealing bar 42 prior to the formation of the bottom transverse seal 44 and stand-up geometry 46. The advantage of this action is that there is no need for a secondary seal bar and mechanism 42 to actuate it.

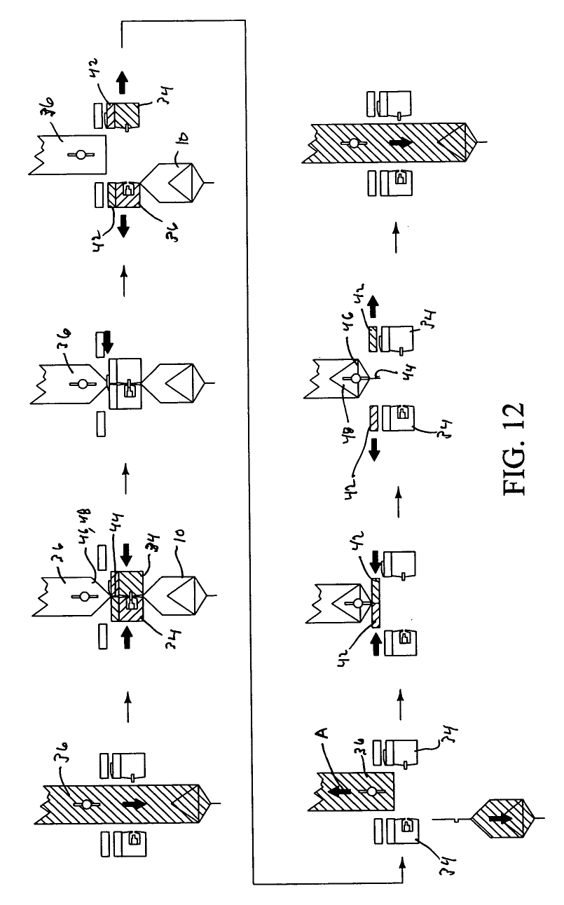

In FIG. 12, a further alternative embodiment of VFFS machinery is shown. This embodiment is another alternative to the embodiment of FIG. 10 in which the film is reversed (see arrow A) during the formation of bag 10. This allows the bottom edge of film 36 to be aligned to the secondary seal bar 42 prior to the formation of the bottom transverse seal 44 and stand-up geometry 46. The advantage of this action is that the bottom film edge may be aligned electronically through a VFFS machine computer controller. This eliminates the mechanical alignment of the secondary sealing bars, gusseting fingers, and forming tube attachment.

It should be noted that other variations of the sequence of operation of the embodiments of FIGS. 10-12 are contemplated, based on the many different designs and functions of VFFS machines in the market today. For example, some VFFS machinery operates with continuous motion versus intermittent motion. It is contemplated that this technology could be adapted to work with the present invention as well.

Additionally, the present invention may be adapted to be applied to horizontal form fill and seal flow wrapping technology. This should be differentiated from the horizontal form, vertical fill and seal market in which “stand-up pouch” style bags are formed.

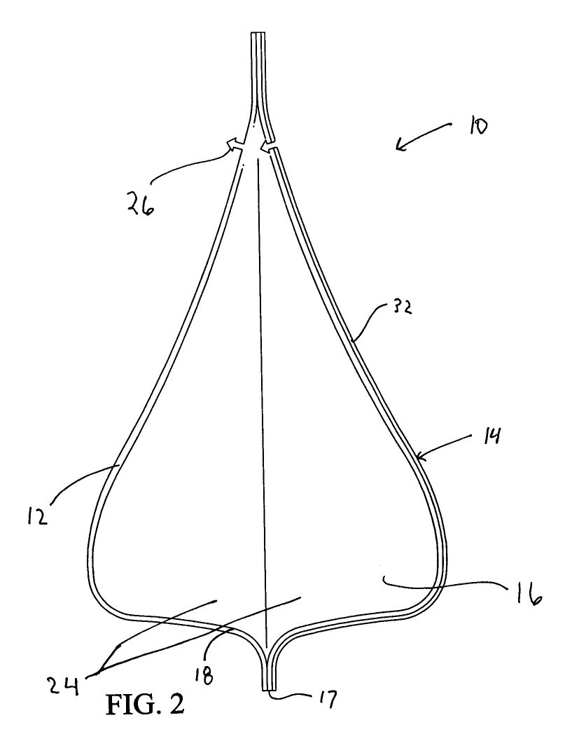

The seals of the present invention may be accomplished via a seal bar or similar device or procedure. As stated above, the seals are preferably located longitudinally along a portion of the bag, for example, along the rear wall 14 of the bag 10, shown as 32 in FIGS. 2 and 3. The seal 32 preferably extends below the flat bottom 18 portion of bag 10. See FIGS. 1-3.

The present invention has several advantages over existing packages in use today. Typical flat-bottom bags are required to be gusseted on the top and bottom seals. Having a gusset on the top seal adds a great deal of complexity to the addition of a reclosable feature. Multiple layers of film are folded within the seal not allowing normal reclosable features to be used, such as a zipper or slider mechanism. The present invention provides a reclosable feature on a gusseted stand-up bag. Moreover, the present invention requires the utilization of the special sealing jaws and gusseting manufacturing equipment for only the bottom of the package. Consequently, manufacturing time, assembly complexity and costs are greatly reduced.

Those skilled in the art will further appreciate that the present invention may be embodied in other specific forms without departing from the spirit or central attributes thereof. In that the foregoing description of the present invention discloses only exemplary embodiments thereof, it is to be understood that other variations are contemplated as being within the scope of the present invention. Accordingly, the present invention is not limited in the particular embodiments that have been described in detail therein. Rather, reference should be made to the appended claims as indicative of the scope and content of the present invention.

What is claimed is:

1. A stand-up plastic bag, comprising:
(a) an opposed front wall and rear wall, each wall having an upper and lower edge and longitudinal edges, such that the walls define a bag opening at upper edges thereof;
(b) a pair of gusseted sides disposed between the opposed front and rear walls and running along the longitudinal edges, wherein the gussets are located on a lower portion of the sides;
(c) a flat bottom portion adjacent a lower portion the front and rear walls and the sides, the bottom portion, front and rear walls, and the sides configured such that the bag conforms to a stand-up bag orientation;
(d) the front and rear walls, the sides, and the bottom portion define an interior volume of the bag; and
(e) a reclosable device located proximate the bag opening, such that no gussets are required on the upper portion of the bag, wherein the bag opening may be selectively opened and closed.

2. The stand-up bag of claim 1, wherein said front, rear and sides and said bottom portion are composed of a multi-layered film of thermoplastic material.

3. The stand-up bag of claim 1, wherein said bottom portion having portions of the front and rear walls interconnected together at contiguous portions to form a seal extending below the periphery of said bottom portion.

4. The stand-up bag of claim 1, wherein said front and rear walls have opposite longitudinal edges joined together by an elongate seal made at a contiguous portion thereof.

5. The stand-up bag of claim 1, wherein the reclosable device is a zipper lock.

6. The stand-up bag of claim 1, wherein the reclosable device is a slider.

7. The stand-up bag of claim 1, wherein the reclosable device is an easy-snap mechanism.

8. A reclosable bag comprising:
a pair of gusseted sides disposed between a front wall and a rear wall, wherein the gussets are located on a lower portion of the sides;
a flat bottom portion adjacent a lower portion the front and rear walls and the sides, the bottom portion defining a base for the stand-up orientation of the bag;
a reclosable device located proximate a bag opening, such that no gussets are required on an upper portion of the bag; and
wherein the bag is formed on a vertical form filling system.

9. The reclosable bag of claim 8, further comprising front and rear walls have opposite longitudinal edges joined together by an elongate seal made at a contiguous portion thereof.

10. The method of forming a self-standing reclosable package comprising:
providing a supply web;
forming an opposed front wall and rear wall, wherein each wall has an upper and lower edge and longitudinal edges, such that the walls define a package opening at upper edges thereof;
forming a pair of gusseted sides between the front and rear walls, wherein the gussets are located on a lower portion of the sides;
forming a flat bottom portion adjacent a lower portion the front and rear walls and the sides, the bottom portion, front and rear walls, wherein the sides are configured such that the package conforms to a stand-up orientation, and wherein the front and rear walls, the side walls, and the bottom portion define an interior volume of the package;
attaching a reclosable device proximate the package opening, such that no gussets are required on the upper portion of the package; and
wherein a flexible package comprising a package body for enclosing a product is formed.

11. The method of claim 10, further comprising forming a base seal where the front and rear walls are interconnected together at contiguous portions, such that the gussets are formed on the sides when forming the base seal.

12. The method of claim 10, further comprising forming the bag using a vertical form filling system.

13. A manufactured self-standing package containing goods having a reclosable opening, the web manufactured package formed by:
providing a supply web;
providing a packaging mechanism for placing goods within the package formed from the supply web;
forming an opposed front wall and rear wall, wherein each wall has an upper and lower edge and longitudinal edges, such that the walls define a package opening at upper edges thereof;
forming a pair of gusseted sides between the front and rear walls, wherein the gussets are located on a lower portion of the sides;
forming a flat bottom portion adjacent a lower portion the front and rear walls and the sides, the bottom portion, front and rear walls, wherein the sides configured such that the package conforms to a stand-up orientation, and wherein the front and rear walls, the sides, and the bottom portion define an interior volume of the package;
attaching a reclosable device proximate the package opening, such that no gussets are required on the upper portion of the package;
filling the interior volume of the package with goods; and
wherein a flexible package comprising a package body enclosing goods is formed.

14. The manufactured self-standing package of claim 13, wherein the packaging mechanism is a vertical form filling system.

15. The manufactured self-standing package of claim 13, further comprising:
forming a seal along the bottom portion of the package, wherein portions of the front and rear walls are interconnected at contiguous portions to form the seal extending below the periphery of said bottom portion; and
forming a seal along the opposite longitudinal edges of the front and rear walls, wherein the elongate seal is made at a contiguous portion thereof and runs longitudinally along the rear wall.

16. The manufactured self-standing package of claim 15, further comprising covering the opening of the package to enclose the goods.

17. A stand-up plastic bag, comprising:
(a) an opposed front wall and rear wall, each wall having an upper and lower edge and longitudinal edges, such that the walls define a bag opening at upper edges thereof;
(b) a pair of gusseted sides disposed between the opposed front and rear walls and running along the longitudinal edges, wherein the gussets are located on a lower portion of the sides;
(c) a flat bottom portion adjacent a lower portion the front and rear walls and the sides, the bottom portion, front and rear walls, and the sides configured such that the bag conforms to a stand-up bag orientation; and
(d) the front and rear walls, the sides, and the bottom portion define an interior volume of the bag; and

18. The stand-up bag of claim 17, wherein said bottom portion having portions of the front and rear walls interconnected together at contiguous portions to form a seal extending below the periphery of said bottom portion.

19. The method of forming a self-standing reclosable package comprising:
providing a supply web;
forming an opposed front wall and rear wall, wherein each wall has an upper and lower edge and longitudinal edges, such that the walls define a package opening at upper edges thereof;
forming a pair of gusseted sides between the front and rear walls, wherein the gussets are located on a lower portion of the sides;
forming a flat bottom portion adjacent a lower portion the front and rear walls and the sides, the bottom portion, front and rear walls, wherein the sides are configured such that the package conforms to a stand-up orientation, and wherein the front and rear walls, the side walls, and the bottom portion define an interior volume of the package;
forming a base seal where the front and rear walls are interconnected together at contiguous portions, such that the gussets are formed on the sides when forming the base seal; and
wherein a flexible package comprising a package body for enclosing a product is formed.

20. The method of claim 19, further comprising forming the bag using a vertical form filling system.
